(19) United States
(12) Patent Application Publication
(10) Pub. No.: US 2025/0283661 A1
(43) Pub. Date: Sep. 11, 2025

(54) Drying Apparatus for Secondary Battery

(71) Applicant: SK On Co., Ltd., Seoul (KR)

(72) Inventors: Sang Heon SONG, Daejeon (KR); Dong Hyun LEE, Daejeon (KR)

(21) Appl. No.: 19/014,417

(22) Filed: Jan. 9, 2025

(30) Foreign Application Priority Data
Mar. 11, 2024 (KR) 10-2024-0034024

(51) Int. Cl. F26B 3/347; H01M 4/04; H05B 6/78

(52) U.S. Cl. CPC F26B 3/347; H05B 6/788; H01M 4/04

(57) ABSTRACT

A drying apparatus for secondary battery, wherein the drying apparatus dries an electrode sheet including an electrode current collector, a coated portion on which an electrode active material is applied on at least one surface of the electrode current collector, and a non-coated portion on which the electrode active material is not applied, wherein the coated portion is disposed to be parallel to a first direction to form at least one electrode line, includes an induction heating unit disposed to face the electrode sheet and drying the coated portion through electromagnetic induction, wherein the induction heating unit includes a multi-coil portion including a plurality of coils having different heating frequencies; and a switch portion provided to selectively apply current to any one of the plurality of coils.

### CROSS-REFERENCE TO RELATED APPLICATIONS

This patent document claims the priority and benefits of Korean Patent Application No. 10-2024-0034024 filed on Mar. 11, 2024, the disclosure of which is incorporated herein by reference in its entirety.

### TECHNICAL FIELD

The disclosure and implementations disclosed in this patent document generally relate to a drying apparatus for secondary battery.

### BACKGROUND

Secondary batteries, unlike primary batteries, have convenience of being able to be charged and discharged, and are thus receiving much attention as a power source for various mobile devices, electric vehicles, and the like.

Such secondary batteries may include battery cells in which an electrode assembly formed by stacking a positive electrode plate, a negative electrode plate, and a separator or by winding the same in a roll shape is accommodated in a case. A plurality of battery cells may be stacked in a predetermined direction and accommodated in a battery module or a battery pack.

Meanwhile, in a secondary battery manufacturing process, a positive electrode active material or a negative electrode active material may be thinly applied to a surface of a current collector of an electrode sheet, to form a positive electrode plate and a negative electrode plate, respectively. More specifically, the electrode sheet may include a non-coated portion, which is a portion of the current collector in which the electrode active material is not applied, and a coated portion, which is a portion of the current collector in which the electrode active material is applied.

Here, it is important to quickly and evenly dry the coated portion in terms of improving quality of the secondary battery and efficiency of the secondary battery manufacturing process.

### SUMMARY

According to an aspect of the present disclosure, a drying apparatus for secondary battery, capable of quickly drying an electrode sheet, may be provided.

According to an aspect of the present disclosure, a drying apparatus for secondary battery, capable of improving drying quality, may be provided.

A battery cell used in a drying apparatus for secondary battery of the present disclosure may be widely applied in green technology fields such as an electric vehicle, a battery charging station or solar power generation, wind power generation, or the like using batteries, or the like. In addition, the battery cell of the present disclosure may be used in an eco-friendly electric vehicle, a hybrid vehicle, or the like to prevent a change in climate by suppressing air pollution and greenhouse gas emissions.

According to an embodiment of the present disclosure, provided is a drying apparatus for secondary battery, wherein the drying apparatus dries an electrode sheet including an electrode current collector, a coated portion on which an electrode active material is applied to at least one surface of the electrode current collector, and a non-coated portion on which the electrode active material is not applied, wherein the coated portion is disposed to be parallel to a first direction to form at least one electrode line, includes an induction heating unit disposed to face the electrode sheet and drying the coated portion through electromagnetic induction, wherein the induction heating unit includes a multi-coil portion including a plurality of coils having different heating frequencies; and a switch portion provided to selectively apply current to any one of the plurality of coils.

According to an embodiment, the switch portion may be connected to one of the plurality of coils having a heating frequency corresponding to the electrode sheet.

According to an embodiment, the plurality of coils may be provided to have different heating frequencies, respectively corresponding to a resonant frequency of at least one electrode sheet.

According to an embodiment, each of the plurality of coils may include at least one first heating coil portion facing the coated portion, and a plurality of second heating coil portions facing the non-coated portion, and the first heating coil portion and the second heating coil portion may be disposed in a second direction, perpendicular to the first direction.

According to an embodiment, the first heating coil portion and the second heating coil portion may be alternately disposed in the second direction.

According to an embodiment, a size of the second heating coil portion may be provided to be smaller than a size of the first heating coil portion, based on the first direction.

According to an embodiment, a size of the first heating coil portion in the second direction may be provided to correspond to a size of the coated portion in the second direction, and a size of the second heating coil portion in the second direction may be provided to correspond to a size of the non-coated portion in the second direction.

According to an embodiment, the electrode lines may be disposed in n rows (where n is a natural number other than 0), the plurality of coils may be configured to have different numbers of first heating coil portions, and the switch portion may be provided to selectively apply current to one coil having n first heating coil portions among the plurality of coils.

According to an embodiment, the plurality of coils may be disposed such that the number of the first heating coil portions increases in the first direction.

According to an embodiment, the multi-coil portion may be disposed as a plurality of multi-coil portions in the first direction.

According to an embodiment, the drying apparatus may further include a wavelength drying unit irradiating a wave having a predetermined frequency to dry the coated portion, and the wavelength drying unit may include at least one of a microwave drying portion irradiating a microwave to the electrode sheet or a laser drying portion irradiating a laser to the electrode sheet.

According to an embodiment, the induction heating unit and the wavelength drying unit may be disposed to face each other, with the electrode sheet interposed therebetween.

According to an embodiment, the wavelength drying unit may include both the microwave drying portion and the laser drying portion, and the microwave drying portion and the laser drying portion may be disposed alternately in the first direction.

According to an embodiment, the multi-coil portion may be disposed as a plurality of multi-coil portions in the first direction, and the plurality of multi-coil portions may be disposed to face one of the microwave drying portion or the laser drying portion.

According to an embodiment, at least one of the microwave drying portion or the laser drying portion and the multi-coil portion may be disposed alternately based on the first direction.

In addition, according to another embodiment of the present disclosure, a drying apparatus for secondary battery, wherein the drying apparatus dries an electrode sheet including an electrode current collector, a coated portion on which an electrode active material is applied on at least one surface of the electrode current collector, and a non-coated portion on which the electrode active material is not applied, wherein the coated portion forms n electrode lines disposed in n rows, parallel to a first direction, includes an induction heating unit disposed to face the electrode sheet and drying the coated portion through electromagnetic induction, wherein the induction heating unit includes a plurality of coils including a first heating coil portion corresponding to the coated portion to heat the coated portion, and a switch portion selectively applying current to any one of the plurality of coils, each of the plurality of coils has different numbers of first heating coil portions, and the switch portion selectively applies current to a coil having n first heating coil portions, among the plurality of coils (where n is a natural number other than 0).

The solutions according to the present disclosure have been described above, but are illustrative, and it should be understood that other configurations, not mentioned, are included in the present disclosure even if they are added.

### BRIEF DESCRIPTION OF DRAWINGS

Certain aspects, features, and advantages of the present disclosure may be illustrated by the following detailed description with reference to the accompanying drawings.

FIG. 1 is a schematic diagram of a drying apparatus for secondary battery according to an embodiment of the present disclosure.

FIG. 2 is a schematic diagram of a drying apparatus for secondary battery according to another embodiment of the present disclosure.

FIG. 3 is an exemplary diagram roughly illustrating an electrode sheet being dried through a drying apparatus for secondary battery of the present disclosure.

FIG. 4A is a view illustrating an electrode sheet of a first model in which coated portions are disposed in one row, and FIG. 4B is a view illustrating a multi-coil portion and a switch portion for drying an electrode sheet of a first model.

FIG. 5A is a view illustrating an electrode sheet of a second model in which coated portions are disposed in two rows, and FIG. 5B is a view illustrating a multi-coil portion and a switch portion for drying an electrode sheet of a second model.

FIG. 6A is a view illustrating an electrode sheet of a third model in which coated portions are disposed in three rows, and FIG. 6B is a view illustrating a multi-coil portion and a switch portion for drying an electrode sheet of a third model.

### DETAILED DESCRIPTION

Before a detailed description of the embodiments, the terms or words used in the following description and claims should not be interpreted as limited to their usual or dictionary meanings, and should be interpreted as meanings and concepts that conform to the technical idea of the present disclosure based on the principle that the inventor may appropriately define the concept of the term in order to explain his own invention in the best way. The same reference numbers or symbols described in each drawing represent portions or components that perform substantially the same functions. For convenience of explanation and understanding, the same reference numbers or symbols may be used in different embodiments.

In the following description, singular expressions include plural expressions unless the context clearly indicates otherwise. It should be understood that terms such as “include,” “comprise,” or the like are intended to specify the presence of features, numbers, steps, operations, components, portions, or combinations thereof described in the specification, but do not preemptively exclude the possibility of the presence or addition of at least one other features, numbers, steps, operations, components, portions, or combinations thereof.

In addition, in the following description, expressions such as upward, above, on, upper portion, downward, below, lower portion, lateral, side surface, forward, front, rearward, rear, or the like may be expressed based on the direction illustrated in the drawings, and it should be noted in advance that when a direction of an object changes, it may be expressed differently.

Additionally, in this specification and claims, terms including ordinal numbers such as “first,” “second,” or the like may be used to distinguish between components. These ordinal numbers may be used to distinguish identical or similar components from each other, and the meaning of the term should not be interpreted limitedly due to the use of these ordinal numbers. For example, components combined with these ordinal numbers should not be interpreted as having a limited order of use or arrangement based on the number. As necessary, each ordinal number may be used interchangeably.

Hereinafter, the present disclosure will be described in detail with reference to the drawings.

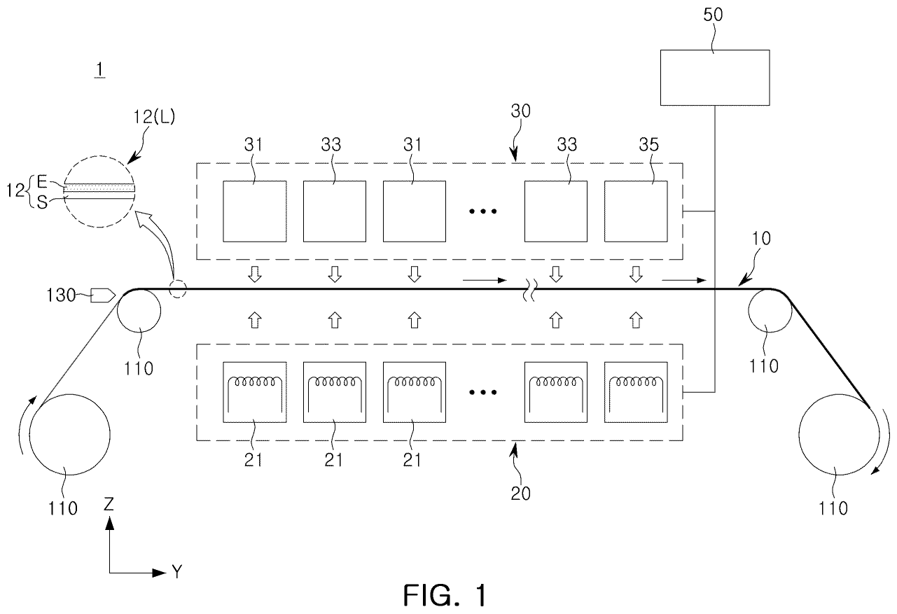

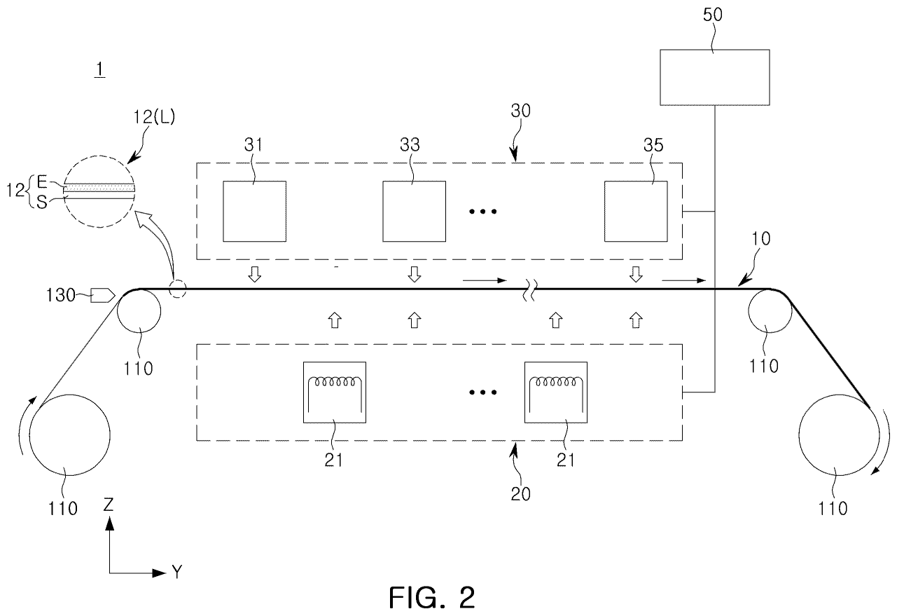

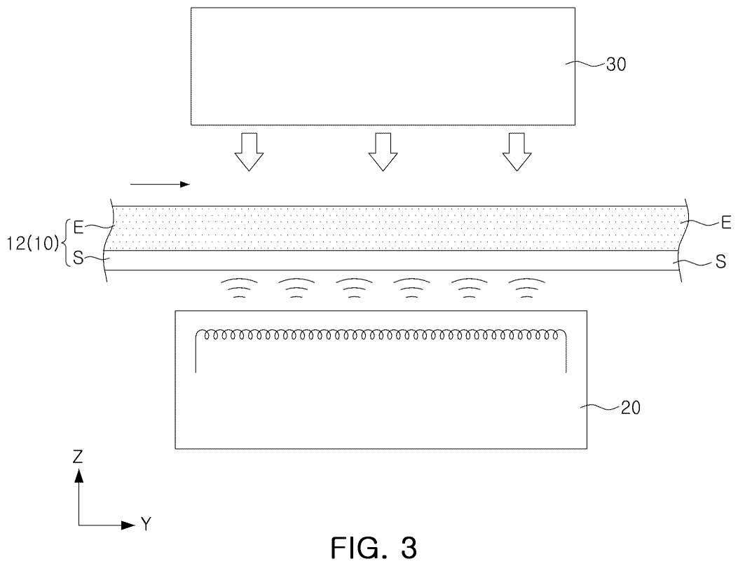

FIG. 1 is a schematic diagram of a drying apparatus for secondary battery according to an embodiment of the present disclosure, FIG. 2 is a schematic diagram of a drying apparatus 1 for secondary battery according to another embodiment of the present disclosure, and FIG. 3 is an exemplary diagram roughly illustrating an electrode sheet being dried through a drying apparatus 1 for secondary battery of the present disclosure.

Referring to FIGS. 1 to 3 together, a drying apparatus 1 for secondary battery of the present disclosure may include a roller unit 110 transporting an electrode sheet 10 in a predetermined direction, a coating unit 130 applying an electrode active material to the electrode sheet 10, and an induction heating unit 20 located to face the electrode sheet 10 and dry the electrode sheet 10.

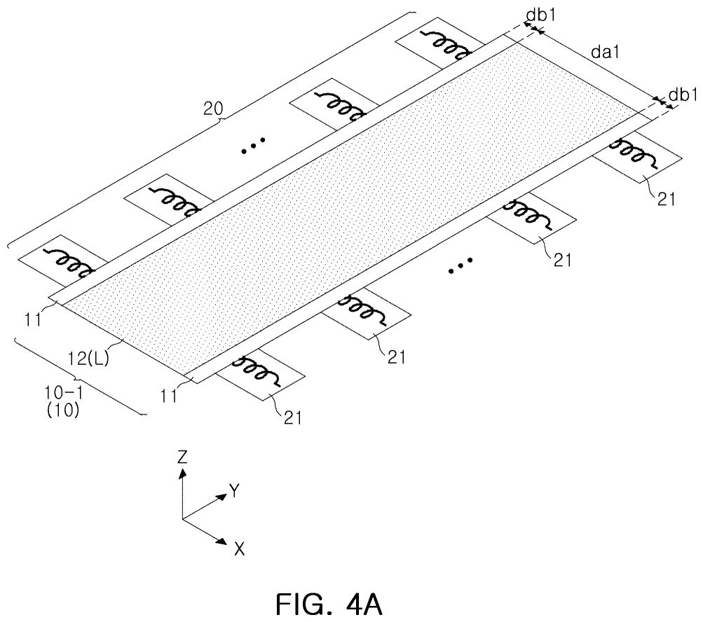

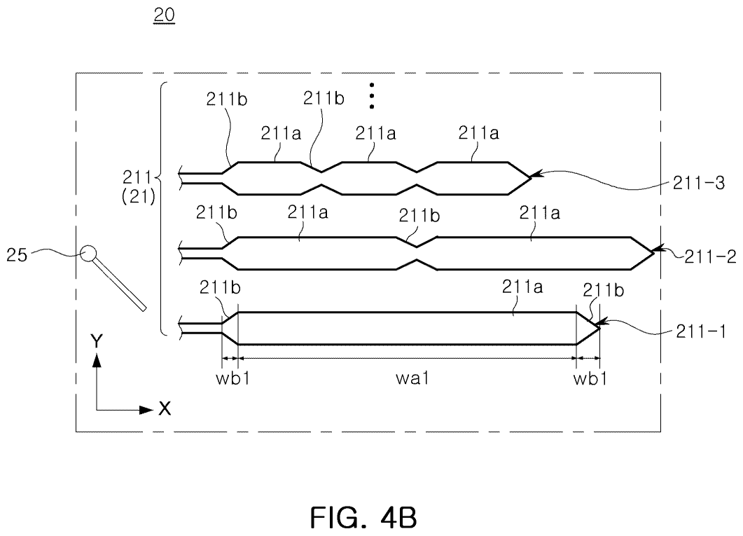

Specifically, a drying apparatus 1 for secondary battery according to an embodiment of the present disclosure, as an electrode sheet 10 including an electrode current collector S, a coated portion 12 on which an electrode active material is applied on at least one surface of the electrode current collector S, and a non-coated portion 11 on which the electrode active material is not applied, in which the coated portion 12 may be disposed to be parallel to a first direction to form at least one electrode line L, may include an induction heating unit 20 disposed to face the electrode sheet 10 and drying the coated portion 12 through electromagnetic induction. In this case, the induction heating unit 20 may include a multi-coil portion 21 including a plurality of coils 211 having different heating frequencies, and a switch portion 25 provided to selectively apply current to any one of the plurality of coils 211 (see FIGS. 4A and 4B).

In addition, a wavelength drying unit 30 disposed to face the electrode sheet 10 to dry the electrode sheet 10, and a drying control unit 50 supplying and controlling power to the induction heating unit 20 and the wavelength drying unit 30, may be included.

The electrode sheet 10 may include an electrode current collector S and an electrode mixture layer E disposed on at least one surface of the electrode current collector S.

A portion of the electrode sheet 10 in which an electrode active material is applied and the electrode mixture layer E is disposed may be defined as the coated portion 12, and a portion of the electrode sheet 10 in which an electrode active material is not applied and the electrode mixture layer E is not disposed may be defined as the non-coated portion 11 (see FIGS. 4A, 5A, and 6A).

For example, the coated portion 12 may include the electrode current collector S and the electrode mixture layer E disposed on at least one surface of the electrode current collector S, but the non-coated portion 11 may include the electrode current collector S and may not include the electrode mixture layer E.

The electrode sheet 10 may form a positive electrode plate or a negative electrode plate, depending on a type of electrode active material applied to the electrode current collector S. For example, the electrode sheet 10 may include the positive electrode plate and the negative electrode plate. In this case, the positive electrode plate may be formed by arranging a positive electrode mixture layer including a positive electrode active material on a positive electrode current collector S among the electrode current collectors, and the negative electrode plate may be formed by arranging a negative electrode mixture layer including a negative electrode active material on a negative electrode current collector S among the electrode current collectors.

The electrode current collector S is not particularly limited as long as it has high electrical conductivity without causing a chemical change in battery. In addition, the electrode current collector S may be provided in the form of a metal thin film such as a film, a sheet, or a foil.

The electrode current collector S may include a positive electrode current collector and a negative electrode current collector.

The positive electrode current collector may include stainless steel, nickel, aluminum, titanium, or an alloy thereof. The positive electrode current collector may also include aluminum or stainless steel surface-treated with carbon, nickel, titanium, or silver. The positive electrode current collector may have a thickness of, but is not limited to, 10 to 50 μm, for example.

The negative electrode current collector may be, but is not limited to, a copper foil, a nickel foil, a stainless steel foil, a titanium foil, a nickel foam, a copper foam, a polymer substrate coated with a conductive metal, or the like. The negative electrode current collector may have a thickness of, but is not limited to, 10 to 50 μm, for example. The electrode composite layer E may be applied to at least one surface of the electrode current collector S.

The electrode composite layer E may include a positive electrode composite layer and a negative electrode composite layer.

The positive electrode composite layer may include a positive electrode active material. The positive electrode active material may include a compound capable of reversibly intercalating and deintercalating lithium ions. According to example embodiments, the positive electrode active material may include a lithium-nickel metal oxide. The lithium-nickel metal oxide may further include at least one of cobalt (Co), manganese (Mn), or aluminum (Al).

The negative electrode composite layer may include a negative electrode active material. A material capable of adsorbing and desorbing lithium ions may be used as the negative electrode active material. For example, as the negative electrode active material, a carbon-based material such as crystalline carbon, amorphous carbon, a carbon composite, or carbon fiber; lithium metal; lithium alloy; a silicon (Si)-containing material, a tin (Sn)-containing material, or the like may be used. The electrode sheet 10 may be wound around the roller unit 110, and may be transported in an MD direction (lengthwise or Y-axis direction).

In a conventional hot air drying device, a surface of a coated portion may be directly heated, such that heat transfer may be performed in order of drying from an upper portion of the coated portion (far from a current collector) to a lower portion of the coated portion (close to the current collector). Therefore, a dry film may be formed on the surface of the coated portion. In this case, moisture in the coated portion (close to the current collector) may delay a drying time due to the dry film. In addition, when the dry film is generated, quality of an electrode assembly may deteriorate, such as defects due to the occurrence of cracks, boiling, or the like on the surface.

The present disclosure may minimize occurrence of the dry film, thereby securing quality of appearance of the electrode sheet 10 while shortening the drying time thereof. This will be described in detail below.

The present disclosure may include an induction heating unit 20 inductively heating the electrode sheet 10 using a plurality of coils 211 (see FIG. 4A).

The induction heating unit 20 may be disposed to face at least one of an upper surface or a lower surface of the electrode sheet 10. In the drawings, the induction heating unit 20 is illustrated as being disposed below the electrode sheet 10, but the present disclosure is not necessarily limited thereto.

The induction heating unit 20 may be disposed to face the electrode sheet 10, and may heat the electrode sheet 10 through electromagnetic induction. More specifically, the induction heating unit 20 may include a plurality of coils 211, and may heat the electrode current collector S of the electrode sheet 10 through induction heating.

According to an embodiment, the induction heating unit 20 of the present disclosure may heat the electrode current collector S, not the coated portion (12, specifically, the electrode mixture layer E applied to the coated portion 12). The coated portion 12 may be dried by heating a lower surface (surface contacting the electrode current collector S) by the electrode current collector S. For example, heat may be transferred from a lower surface (close to the electrode current collector S) of the coated portion 12 to an upper surface (far from the electrode current collector; S) of the coated portion 12.

Through this, the induction heating unit 20 of the present disclosure may minimize generation of a dry film and shorten a drying time by heating from an inside of the coated portion 12.

Referring to FIGS. 4A to 6B in advance, the induction heating unit 20 may include a multi-coil portion 21 including a plurality of coils 211, and a switch portion 25 selectively applying current to the multi-coil portion 21. The above-described structure will be described later in FIG. 4A below.

According to an embodiment of the present disclosure, a wavelength drying unit 30 irradiating a wave having a predetermined frequency to dry the coated portion may be further included.

According to an embodiment, the wavelength drying unit 30 may include at least one of a microwave drying portion 31 irradiating a microwave to the electrode sheet 10 or a laser drying portion 33 irradiating a laser to the electrode sheet 10.

As described above, the multi-coil portions 21 may be disposed in multiple numbers in the MD direction. In this case, according to an embodiment, the multi-coil portions 21 may be disposed to face at least one of the microwave portion 31 and the laser drying portions 33.

In addition, according to an embodiment, the microwave drying portions 31 or the laser drying portions 33 may be disposed to be spaced apart from each other in a first direction (MD direction or Y-axis direction). In this case, the multi-coil portions 21 may be disposed to face each other in a height direction (Z-axis direction) in a space between the microwave portions 31 and the laser drying portions 33.

For example, at least one of the microwave portions 31 or the laser drying portions 33 and the multi-coil portions 21 may be disposed alternately in the MD direction (first direction or Y-axis direction).

The wavelength drying unit 30 may be disposed to face at least one of an upper surface or a lower surface of the electrode sheet 10 to dry the electrode sheet 10.

The wavelength drying unit 30 may include a microwave drying portion 31 applying a microwave having a frequency of 300 MHz or higher to the coated portion 12, to generates heat in a dielectric (electrode mixture layer E of the coated portion 12), and a laser drying portion 33 applying a laser beam having a wavelength of a predetermined range, to dry the electrode mixture layer E of the coated portion 12.

The microwave drying portion 31 may generate heat in the electrode mixture layer E by using a frequency in the range of 300 MHz to 300 GHz. The microwave drying portion 31 may directly heat an interior of the electrode mixture layer E, which is a dielectric, without heating the electrode current collector S, which is a metal substrate. Through this, occurrence of the dry film may be minimized and a drying time may be reduced.

The laser drying portion 33 may dry the electrode mixture layer E by irradiating a laser beam to the electrode mixture layer E of the coated portion 12. The laser drying portion 33 may irradiate the laser beam linearly or planarly to the upper surface (surface located far from the electrode current collector S) of the coated portion 12.

The laser drying portion 33 may irradiate the laser beam having a wavelength of a predetermined range. For example, the laser drying portion 33 may irradiate the laser beam having a wavelength of 850 nm or less.

The range of this wavelength may be changed depending on purified water included in the undried electrode mixture layer E, and a material of the electrode mixture layer E.

For example, when the electrode mixture layer E is a negative active material including graphite, the laser drying portion 33 may irradiate the laser beam having a wavelength of 400 nm to 600 nm, more specifically, 600 nm or less. In this range, a large difference in light absorbance may be formed between purified water and graphite. Specifically, light absorbance of graphite may be greater than light absorbance of purified water, within this range.

Therefore, when irradiating the laser beam in the above-described range, graphite, which is the material of the electrode composite layer E, may be dried by heating and evaporating water. In addition, when an irradiation wavelength of the laser drying portion 33 exceeds 850 nm, absorption of purified water and absorption of graphite may gradually become similar to each other. In addition, damage may be inflicted on the active material including graphite within this range. Therefore, a wavelength range irradiated by the laser drying portion 33 may be a wavelength range (850 nm or less) minimizing damage to the active material, but a specific wavelength range may be changed depending on a type of the active material. (For example, when the active material is graphite, the wavelength range may be 400 nm to 600 nm.)

The wavelength drying unit 30) of the present disclosure may further include other drying means in addition to the microwave drying portion 31 and the laser drying portion 33. For example, the wavelength drying unit 30 may further include general drying means such as an ultraviolet drying portion 35 irradiating a wavelength in an ultraviolet range, an air drying portion (not illustrated) supplying air for drying, or the like.

In addition, according to an embodiment, in the wavelength drying unit 30, the microwave drying portion 31 and the laser drying portion 33 may be alternately disposed in the MD direction (Y-axis direction). However, the present disclosure is not limited to this arrangement.

In addition, the induction heating unit 20 and the wavelength drying unit 30, described above, in the present disclosure may be disposed to face each other, with the electrode sheet 10 interposed therebetween. For example, the induction heating unit 20 may be disposed to face a first surface of the electrode sheet 10, and the wavelength drying unit 30 may be disposed to face a second surface of the electrode sheet 10.

For example, since the laser drying portion 33 irradiates a laser beam to the surface of the electrode mixture layer E, the laser drying portion 33 may be disposed to face the electrode mixture layer E. For example, the wavelength drying unit 30 and the electrode mixture layer E may face the electrode mixture layer E, without an obstacle (for example, an electrode current collector S) therebetween.

In addition, the induction heating unit 20 may heat the electrode current collector S, not the electrode mixture layer E, through electromagnetic induction, and, thus, may not be necessarily disposed to face the electrode mixture layer E.

Taking FIG. 3 as an example, when, in an electrode sheet 10 of the present disclosure, an electrode mixture layer E is applied to an upper surface of an electrode current collector S, a laser drying portion 33 may be disposed above the electrode sheet 10, and, regardless thereof, an induction heating unit 20 may be disposed in at least one direction of an upward direction or a downward direction.

In addition, a drying apparatus 1 for secondary battery of the present disclosure may be disposed such that the induction heating unit 20 and the wavelength drying unit 30 face each other in the height direction (Z-axis direction), as illustrated in FIG. 1. However, the present disclosure is not limited thereto, and the induction heating unit 20 and the wavelength drying unit 30 may be disposed alternately in a zigzag manner in the MD direction (Y-axis direction), as illustrated in FIG. 2.
a drying apparatus 1 for secondary battery of the present disclosure may further include a drying control unit 50 controlling the induction heating unit 20 and the wavelength drying unit 30.

The drying control unit 50 may appropriately control current, wavelength, or the like of the induction heating unit 20 and the wavelength drying unit 30. In addition, the drying control unit 50 may include a power supply unit (not illustrated) that supplies power to the induction heating unit 20 and the wavelength drying unit 30. In addition, the drying control unit 50 may also control selective current application of the switch portion 25 to be described later.

Hereinafter, a structure of the induction heating unit 20 of a drying apparatus 1 for secondary battery of the present disclosure will be described in detail with reference to FIGS. 4A to 6B. In the electrode sheet 10 of the present disclosure, the coated portion 12 may be applied lengthwise in the MD direction (Y-axis direction), to form electrode lines L disposed in at least one rows.

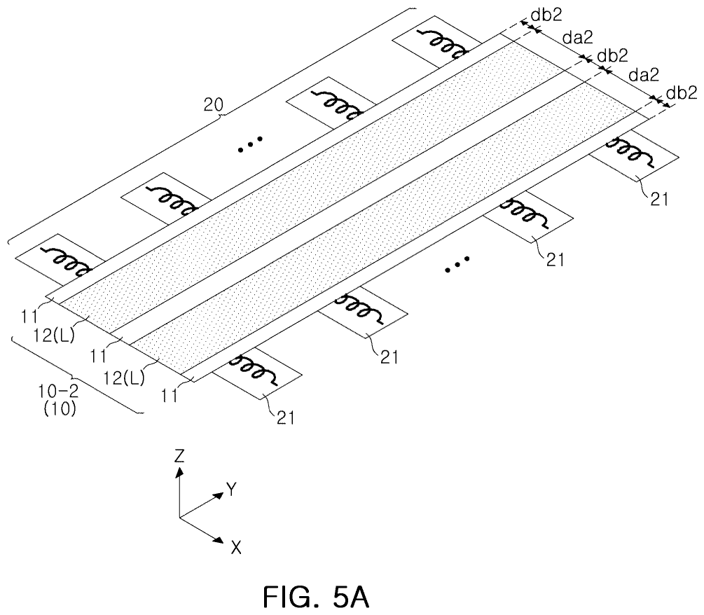

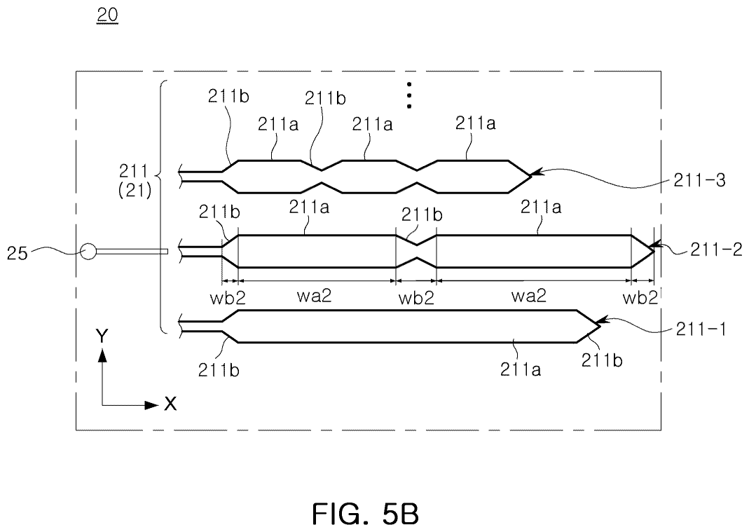

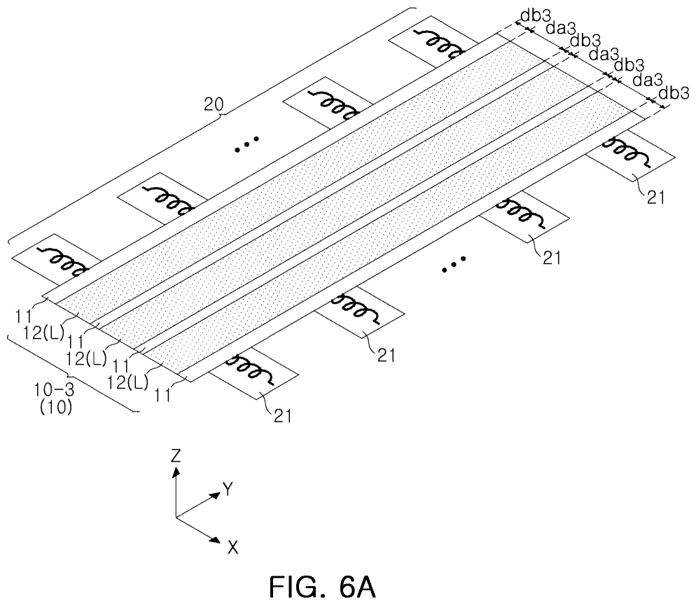

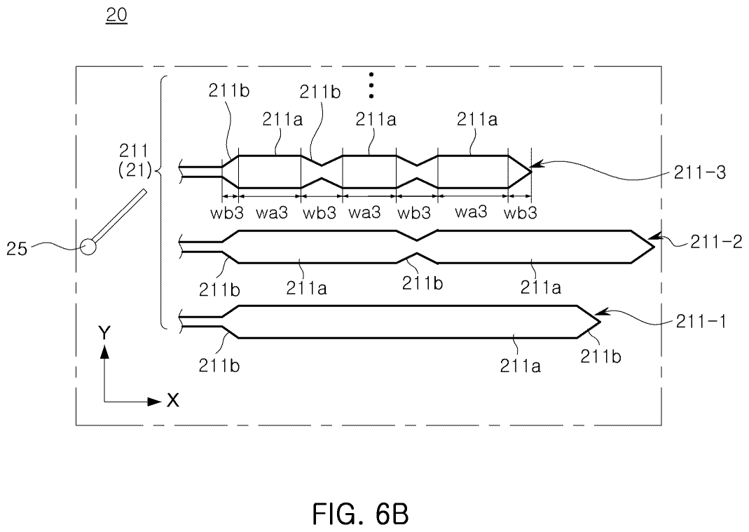

FIG. 4A below illustrates an electrode sheet 10-1 (“first model”) having one electrode line L formed by the coated portion 12, FIG. 5A illustrates an electrode sheet 10-2 (“second model”) having two electrode lines L, and FIG. 6A illustrates an electrode sheet 10-3 (“third model”) having three electrode lines L. However, the present disclosure is not limited thereto, and more electrode lines may be formed.

As described below, the present disclosure may be provided with an electrode sheet 10 having at least one electrode line L, and depending on the number of electrode lines L, one coil 211 may be selected from a multi-coil portion 21 by a switch portion 25, described below.

FIG. 4A is a view illustrating an electrode sheet of a first model in which coated portions are disposed in one row, and FIG. 4B is a view illustrating a multi-coil portion and a switch portion for drying an electrode sheet of a first model.

Referring to FIGS. 4A and 4B together, an induction heating portion 20 of the present disclosure may include a multi-coil portion 21 including a plurality of coils 211, and a switch portion 25 selectively connected to at least one of the plurality of coils 211.

The multi-coil portion 21 may include a plurality of coils 211. More specifically, the multi-coil portion 21 may include a plurality of coils 211 having different heating frequencies f. The plurality of coils 211 may have different shapes corresponding to a non-coated portion 11 and a coated portion 12 in an electrode sheet 10. The plurality of coils 211 may include a first heating coil portion 211a corresponding to the coated portion 12, and a second heating coil portion 211b corresponding to the non-coated portion 11. The first heating coil portion 211a and the second heating coil portion 211b may be disposed in a direction (X-axis direction or second direction), perpendicular to an extension direction (Y-axis direction or first direction) of an electrode line L.

For example, the first heating coil portion 211a and the second heating coil portion 211b may be alternately disposed in the second direction (X-axis direction).

A term ‘corresponding (to)’ may mean being disposed to face each other. For example, the first heating coil portion 211a may be disposed to face the coated portion 12, and the second heating coil portion 211b may be disposed to face the non-coated portion 11. The plurality of coils 211 may be provided in different shapes, and may have different heating frequencies f. The heating frequency f may be a resonant frequency corresponding to one of the plurality of models of the electrode sheet 10. The plurality of coils 211 may have different heating frequencies f and accordingly, may have different numbers of the first heating coil portions 211a. For example, the plurality of coils 211 may be provided to have different heating frequencies f corresponding to resonant frequencies of at least one electrode sheets 10.

For example, the plurality of coils 211 may include a first coil 211-1 having one first heating coil portion 211a, a second coil 211-2 having two first heating coil portions 211a, and a third coil 211-3 having three first heating coil portions 211a.

In this case, the first coil 211-1 may generate a first heating frequency f1 corresponding to an electrode sheet 10-1 of the first model, the second coil 211-2 may generate a second heating frequency f2 corresponding to an electrode sheet 10-2 (see FIG. 5A) of the second model, and the third coil 211-3 may generate a third heating frequency f3 corresponding to an electrode sheet 10-3 (see FIG. 6A) of the third model.

For example, among the plurality of coils 211, an nth coil 211-n may generate a heating frequency f corresponding to an electrode sheet 10-n of an nth model, where the number of electrode lines L is n.

To concentrate induction heating on the coated portion 12 to which an electrode mixture layer E is applied, the induction heating unit 20 of the present disclosure may be provided with a shape in which a size (or width) of the second heating coil portion 211b corresponding to the non-coated portion 11 in the MD direction (first direction or Y-axis direction) decreases. For example, the induction heating unit 20 may be provided with a shape in which a size decreases in a section corresponding to the non-coated portion 11, an increase in temperature by induction heating in the non-coated portion 11 may be lower than that in the coated portion 12 due to the magnetic field offset occurring in this portion.

Specifically, a size (or width) of the second heating coil portion 211b may be provided to be smaller than a size (or width) of the first heating coil portion 211a, based on the MD direction (first direction or Y-axis direction).

The switch portion 25 may be selectively electrically connected to one coil 211 among the plurality of coils 211. The switch portion 25 may connect a coil 211 having a heating frequency f corresponding to a model of the electrode sheet 10, i.e., the number of electrode lines L, and a power supply unit. For example, the switch portion 25 may be connected to any one coil among the plurality of coils 211 having a heating frequency f corresponding to the electrode sheet 10.

Referring again to FIGS. 4A and 4B, an electrode sheet 10 may have a coated portion 12 disposed in one row, and an electrode line L may be disposed in one row. In this case, a switch portion 25 may supply power to a first coil 211-1 among a plurality of coils 211 having a heating frequency f1 corresponding to a resonant frequency of a first model electrode sheet 10-1 in which the electrode lines L are disposed in one row.

For example, the present disclosure may perform electromagnetic induction heating optimized for the electrode sheet 10 by only controlling the switch portion 25 even when the number of electrode lines L is changed.

In a TD direction (second direction or X-axis direction) of the first model electrode sheet 10-1, a width da1 of the coated portion 12 may correspond to a width wa1 of a first heating coil portion 211a of a first coil 211-1, and a width db1 of the non-coated portion 11 may correspond to a width wb1 of a second heating coil portion 211b of the first coil 211-1.

FIG. 5A is a view illustrating an electrode sheet of a second model in which coated portions are disposed in two rows, and FIG. 5B is a view illustrating a multi-coil portion and a switch portion for drying an electrode sheet of a second model.

Referring to FIGS. 5A and 5B, a second model electrode sheet 10-2 having two electrode lines L, and an operation of a switch portion 25 according thereto may be confirmed. The contents described above in FIGS. 4A and 4B will be omitted and described.

Referring to FIG. 5A, an electrode sheet 10 may be a second model electrode sheet 10-2 in which a coated portion 12 is disposed in two rows, e.g., an electrode line L is disposed in two rows. Referring to FIG. 5B, in this case, a switch portion 25 may supply power to a second coil 211-2 having a second heating frequency f2 corresponding to a resonant frequency of the second model electrode sheet 10-2, among a plurality of coils 211.

In this case, a width wa2 of a first heating coil portion 211a may be provided to correspond to a width da2 of a coated portion 12, and a width wb2 of a second heating coil portion 211b may be provided to correspond to a width db2 of a non-coated portion 11.

Referring again to FIGS. 4A to 5B, a size (or width) of the first heating coil portion 211a in the TD direction (second direction or X-axis direction) may be provided to correspond to a size (or width) of the coated portion 12 in the TD direction, and a size (or width) of the second heating coil portion 211b in the TD direction may be provided to correspond to a size of the non-coated portion 11 in the TD direction.

FIG. 6A is a view illustrating an electrode sheet of a third model in which coated portions are disposed in three rows, and FIG. 6B is a view illustrating a multi-coil portion and a switch portion for drying an electrode sheet of a third model.

Referring to FIGS. 6A and 6B, a third model electrode sheet 10-3 having two electrode lines L, and an operation of a switch portion 25 according thereto may be confirmed. The contents described above in FIGS. 4A and 4B will be omitted and described.

Referring to FIG. 6A, an electrode sheet 10 may be a third model electrode sheet 10-3 in which a coated portion 12 is disposed in three rows, e.g., an electrode line L is disposed in three rows. Referring to FIG. 6B, in this case, a switch portion 25 may supply power to a second coil 211-2 having a third heating frequency f3 corresponding to a resonant frequency of the third model electrode sheet 10-3, among a plurality of coils 211.

In this case, a width wa3 of a first heating coil portion 211a may correspond to a width da3 of a coated portion 12, and a width wb3 of a second heating coil portion 211b may correspond to a width db3 of a non-coated portion 11.

As described above, a plurality of coils 211 may have different heating frequencies (f1, f2, f3 . . . ), depending on the number or a width (wa1, wa2, wa3 . . . ) of first heating coil portions 211a.

As described above in FIGS. 4A to 6B, a plurality of electrode lines L may be formed.

For example, according to an embodiment of the present disclosure, in a drying apparatus for secondary battery for drying an electrode sheet 10 including an electrode current collector S, a coated portion 12 on which an electrode active material is applied on at least one surface of the electrode current collector S, and a non-coated portion 11 on which the electrode active material is be applied, wherein the coated portion 12 forms n electrode lines disposed in n rows, parallel to a first direction, the drying apparatus includes an induction heating unit 20 disposed to face the electrode sheet 10 and drying the coated portion 12 through electromagnetic induction, wherein the induction heating unit 20 includes a plurality of coils 211 including a first heating coil portion 211a corresponding to the coated portion 12 to heat the coated portion 12, and a switch portion 25 selectively applying current to any one of the plurality of coils 211. In this case, each of the plurality of coils 211 may have different numbers of first heating coil portions 211a (for example, the plurality of coils 211 may include a first coil 211-1 to an nth coil 211-n), and the switch portion 25 may selectively applies current to a coil having n first heating coil portions, among the plurality of coils 211 (where n is a natural number other than 0).

Through this structure, the switch portion 25 may selectively supply current to one coil having an appropriate resonance frequency depending on a model type of the electrode sheet 10, among the plurality of coils 211, thereby performing optimal induction heating for a type of the electrode sheet 10 corresponding thereto.

For example, the switch portion 25 may supply current to a coil 211 having the number of first heating coil portions 211a corresponding to the number of electrode lines L of the electrode sheet 10, among the plurality of coils 211. For example, according to an embodiment of the present disclosure, the electrode lines L may be disposed in n rows (where n is a natural number other than 0), and the plurality of coils 211 may be provided to have different numbers of first heating coil portions 211a, but the switch portion 25 may be provided to selectively apply current to any one coil having n first heating coil portions 211a, among the plurality of coils 211.

For example, referring to FIGS. 6A and 6B, in an electrode sheet 10-3 having three electrode lines L (n=3), the switch portion 25 may supply current by switching to the third coil 211-3 having three first heating coil portions 211a.

In addition, as described above, the first heating coil portion 211a may be disposed between second heating coil portions 211b. For example, the plurality of coils 211 may include a first coil 211-1 including one first heating coil portion 211a and two second heating coil portions 211b, a second coil 211-2 including two first heating coil portions 211a and three second heating coil portions 211b, and a third coil 211-3 including three first heating coil portions 211a and four second heating coil portions 211b.

In the above embodiment, the first coil 211-1 to the third coil 211-3 may be disposed such that the number of the first heating coil portions 211a sequentially increases in the TD direction. The number of the first heating coil portions 211a may increase from the first coil 211-1 to the third coil 211-3. In this manner, the plurality of coils 211 according to an embodiment may be disposed such that the number of the first heating coil portions 211a increases in the MD direction (first direction or the Y-axis direction).

For example, as illustrated in the drawings, the first heating coil portions 211a may be disposed such that the number thereof increases in a direction (Y-axis direction) from the first coil 211-1 to the third coil 211-3.

Referring to FIGS. 4B, 5B, and 6B, a plurality of coils 211 in a multi-coil portion 21 may be disposed such that the number of the first heating coil portions 211a increases in the MD direction (Y-axis direction).

In addition, the multi-coil portions 21 respectively having the plurality of coils 211 may be disposed in plural in the MD direction (first direction or the Y-axis direction).

Although various embodiments the present disclosure have been described in detail above, the scope of the present disclosure is not limited thereto, and it will be obvious to those with average knowledge in the relevant technical field that various modifications and variations may be possible within a scope that does not depart from the technical idea of the present disclosure described in the claims. Some components of the above-described embodiments may be deleted and implemented, and each embodiment may be implemented in combination with each other. The contents described above may be merely examples of applying the principles of the present disclosure, and other configurations may be further included within a scope that does not depart from the scope of the present disclosure.

A drying apparatus for secondary battery according to an embodiment of the present disclosure may quickly dry an electrode sheet.

A drying apparatus for secondary battery according to an embodiment of the present disclosure may improve drying quality of an electrode sheet.

Only specific examples of implementations of certain embodiments may be described. Variations, improvements and enhancements of the disclosed embodiments and other embodiments may be made based on the disclosure of this patent document.

What is claimed is:

1. A drying apparatus for secondary battery, wherein the drying apparatus dries an electrode sheet including an electrode current collector, a coated portion on which an electrode active material is applied on at least one surface of the electrode current collector, and a non-coated portion on which the electrode active material is not applied, wherein the coated portion is disposed to be parallel to a first direction to form at least one electrode line, comprising:
an induction heating unit disposed to face the electrode sheet and drying the coated portion through electromagnetic induction,
wherein the induction heating unit includes:
a multi-coil portion including a plurality of coils having different heating frequencies; and
a switch portion provided to selectively apply current to any one of the plurality of coils.

2. The drying apparatus of claim 1, wherein the switch portion is connected to one of the plurality of coils having a heating frequency corresponding to the electrode sheet.

3. The drying apparatus of claim 1, wherein the plurality of coils are provided to have different heating frequencies, respectively corresponding to a resonant frequency of at least one electrode sheets.

4. The drying apparatus of claim 1, wherein each of the plurality of coils includes at least one first heating coil portion facing the coated portion, and a plurality of second heating coil portions facing the non-coated portion, and
wherein the first heating coil portion and the second heating coil portions are disposed in a second direction, perpendicular to the first direction.

5. The drying apparatus of claim 4, wherein the first heating coil portion and the second heating coil portion are disposed alternately in the second direction.

6. The drying apparatus of claim 4, wherein a size of the second heating coil portion is smaller than a size of the first heating coil portion, based on the first direction.

7. The drying apparatus of claim 4, wherein a size of the first heating coil portion in the second direction is provided to correspond to a size of the coated portion in the second direction, and
a size of the second heating coil portion in the second direction is provided to correspond to a size of the non-coated portion in the second direction.

8. The drying apparatus of claim 4, wherein the electrode lines are disposed in n rows (where “n” is a natural number other than 0),
the plurality of coils are configured to have different numbers of first heating coil portions, and
the switch portion is provided to selectively apply current to one coil having n first heating coil portions among the plurality of coils.

9. The drying apparatus of claim 8, wherein the plurality of coils are disposed such that the number of first heating coil portions increases in the first direction.

10. The drying apparatus of claim 1, wherein the multi-coil portion is disposed as a plurality of multi-coil portions in the first direction.

11. The drying apparatus of claim 1, further comprising a wavelength drying unit irradiating a wave having a predetermined frequency to dry the coated portion, and
wherein the wavelength drying unit includes at least one of a microwave drying portion irradiating a microwave to the electrode sheet or a laser drying portion irradiating a laser to the electrode sheet.

12. The drying apparatus of claim 11, wherein the induction heating unit and the wavelength drying unit are disposed to face each other, with the electrode sheet interposed therebetween.

13. The drying apparatus of claim 12, wherein the wavelength drying unit includes both the microwave drying portion and the laser drying portion, and
the microwave drying portion and the laser drying portion are disposed alternately in the first direction.

14. The drying apparatus of claim 13, wherein the multi-coil portion is disposed as a plurality of multi-coil portions in the first direction, and the plurality of multi-coil portions are respectively disposed to face one of the microwave drying portion or the laser drying portion.

15. The drying apparatus of claim 11, wherein at least one of the microwave drying portion or the laser drying portion and the multi-coil portion are disposed alternately based on the first direction.

16. A drying apparatus for secondary battery, wherein the drying apparatus dries an electrode sheet including an electrode current collector, a coated portion on which an electrode active material is applied on at least one surface of the electrode current collector, and a non-coated portion on which the electrode active material is not applied, wherein the coated portion forms n electrode lines disposed in n rows, parallel to a first direction, comprising:
an induction heating unit disposed to face the electrode sheet and drying the coated portion through electromagnetic induction,
wherein the induction heating unit includes a plurality of coils including a first heating coil portion corresponding to the coated portion to heat the coated portion, and a switch portion selectively applying current to any one of the plurality of coils,
each of the plurality of coils has different numbers of first heating coil portions, and
the switch portion selectively applies current to a coil having n first heating coil portions, among the plurality of coils (where “n” is a natural number other than 0).
